(19) United States
(12) Patent Application Publication
(10) Pub. No.: US 2025/0278571 A1
(43) Pub. Date: Sep. 4, 2025

(54) SYSTEM FOR FINE-GRAINED SENTIMENT ANALYSIS USING A HYBRID MODEL AND METHOD THEREOF

(71) Applicant: GRAPHENE HEALTH TECH PVT LTD, Bangalore (IN)

(72) Inventors: Sandeep Katty SUDHEENDRA, Bangalore (IN); Aravind A. J, Thiruvananthapuram (IN); Aamir Syed ALTAF, Bangalore (IN); Anirudh RAVIKUMAR, Bangalore (IN); Ranjan SATAPATHY, Singapore (SG)

(21) Appl. No.: 19/209,920

(22) Filed: May 16, 2025

Related U.S. Application Data
(63) Continuation-in-part of application No. 17/841,055, filed on Jun. 15, 2022.

(51) Int. Cl. G06F 40/30

(52) U.S. Cl. CPC G06F 40/30

(57) ABSTRACT

The present invention discloses a document processing system for fine-grained sentiment analysis of a document. The system comprises a document receiving component, a sentence analysis component, and a device control component. The document receiving component is operable to receive the document comprising at least one sentence. The sentence analysis component provides a fine-grained sentiment score to each sentence in the document using a hybrid model. The hybrid model provides a continuously varied value to each sentence of the document, depicting how intense an emotion it elicits. The device control component is operable to control a controllable device based on the identified sentiment intensity.

### DESCRIPTION OF THE INVENTION

### Technical Field of the Invention

The present invention discloses a system for document processing. The invention particularly relates to a system for document processing for sentiment analysis and controlling a device based on the analysis.

### BACKGROUND OF THE INVENTION

Sentiment Analysis is the process of computationally determining whether a document including a phrase, a sentence or a group of sentences is positive, negative, or neutral, and then assessing the intensity of sentiment on a continuously graded scale when it is either positive or negative. The existing technologies available for sentiment analysis employ either rule-based algorithms or deep-learning based algorithms, wherein such algorithms are often not scalable and lack robustness. Traditional rule-based systems do not handle context well, resulting in bloated rules, or catastrophic failure; while deep-learning approaches require massive amounts of training data for each domain, making them inflexible for adapting to new domains. Current sentiment intensity measures are either categorical, or coarse-grained, thus lacking the granularity needed for prioritization in business applications. Additionally, existing technologies do not handle nuances of incoming data based on language style—e.g. technical papers, journalistic writing, social media, nor do they adapt well to domain specificity-pest control, hospitality, power tools. As a result, existing technologies provide inaccurate results when the nature of the incoming data is significantly different from training and benchmarked data.

The U.S. Pat. No. 9,336,205B2 titled “System and method for analyzing natural language” relates to a computer implemented method for analyzing natural language to determine a sentiment between two entities discussed in the natural language, comprising the following steps: receiving the natural language at a processing circuitry; analyzing the natural language to determine a syntactic representation which shows syntactic constituents of the analyzed natural language and to determine a sentiment score of each constituent; determining which constituents link the two entities; and calculating an overall sentiment score for the sentiment between the two entities by processing the sentiment score of each constituent of the constituents determined to link the two entities.

The U.S. Pat. No. 8,352,405 titled “Incorporating lexicon knowledge into SVM learning to improve sentiment classification” relates to a sentiment classifier for sentiment classification of content. An aspect classifier is configured to classify content as being related to a particular aspect of information, the aspect classifier incorporating at least a portion of the domain specific sentiment lexicon. A polarity classifier is then configured to classify the content classified by the aspect classifier as having one of a positive sentiment of the particular aspect of information, a negative sentiment of the particular aspect of information or as having no sentiment as to the particular aspect of information. The polarity classifier also incorporating at least a portion of the domain specific sentiment lexicon.

Hence, there exists a need for a solution to predict a continuous sentiment value for different types of data that comprise a single phrase, a sentence, or even a large set of sentences irrespective of source(s) of the sentences.

### SUMMARY OF THE INVENTION

The present invention overcomes the drawbacks of the prior art by disclosing a document processing system for fine-grained sentiment analysis using a hybrid model for processing a document in an automated customer service system. The system comprises a document receiving component, a sentence analysis component, and a device control component. The document receiving component receives the document comprising at least one sentence. The sentence analysis component analyzes each sentence in the document using a hybrid model to identify a sentiment of the document. The device control component is operable to generate a control command(s) based on the identified sentiment to control a controllable device(s).

The present invention provides a continuous sentiment intensity system which is flexible, multilingual, and is capable of accurately predicting a continuous sentiment value and quantifying the sentiments by assigning granular, continuous scores for variable kinds of texts that comprise a single phrase, a sentence, a large set of sentences and so on. In addition to being multilingual, the present invention is better compared to the existing technologies in terms of accuracy and robustness by:
a. Automated lexicon evolution through semantic similarity analysis by using transformer-based word embeddings, reducing the need and frequency of manual updates;
b. Normalization based on unique affect word density rather than document length, producing more reliable sentiment intensity scores across variable-length documents; and
c. Self-calibrating feedback loops that continuously refine the system's performance with minimal human intervention.

Unlike the existing technologies which are not scalable and robust, the present invention is scalable in terms of the sentiment intensity, which is measured on a variable scale, wherein different intensities are assigned to each phrase or sentence.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram of a system for fine-grained sentiment analysis using a hybrid model.

FIG. 2 illustrates a method for system for fine-grained sentiment analysis using a hybrid model.

FIG. 3 illustrates a block diagram of a document processing system in accordance with the present invention.

FIG. 4 illustrates a block diagram of a polarity detection module.

FIG. 5 illustrates a block diagram of a sentiment bucketing module.

FIG. 6 illustrates a block diagram of a sentiment analysis component.

FIG. 7 illustrates a block diagram of a hybrid model.

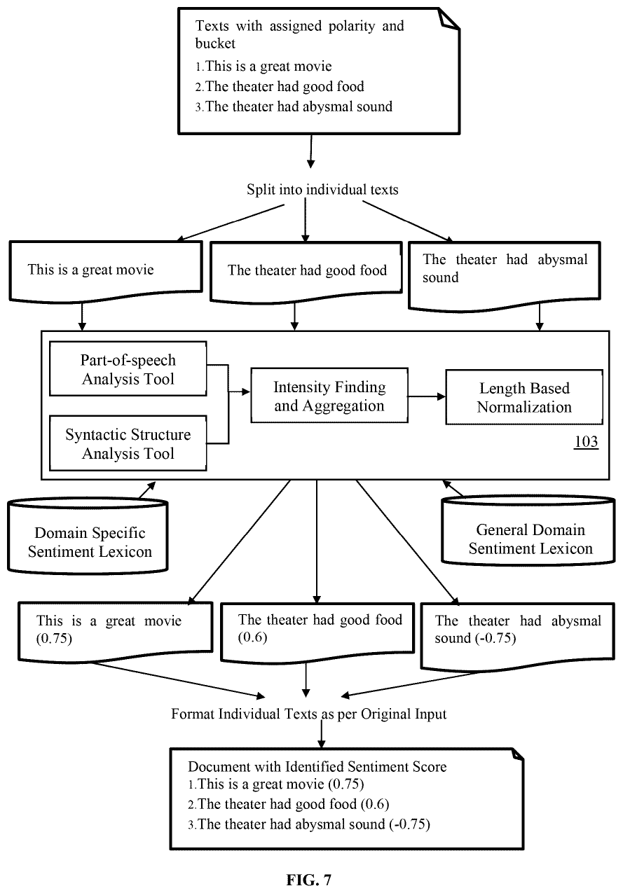

FIG. 8 illustrates a block diagram of a length-based sentiment scoring module.

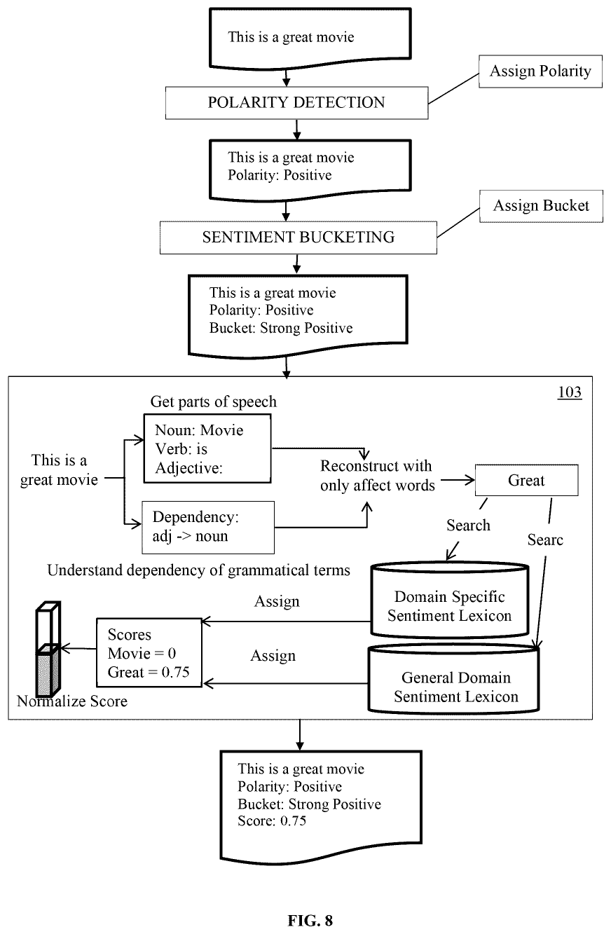

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention. The detailed description and drawings are merely illustrative of the invention rather than limiting, the scope of the invention being defined by the appended claims and equivalents thereof. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any non-claimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the software or electrical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

The term “document” mentioned in different sections of the specification refers to a single phrase, a sentence, or multiple sentences of variable length, language, and sentiment.

The term “affect word(s)” mentioned in different sections of the specification refers to one or more words that convey variable sentiment.

With the advancements in human-machine interaction, an enormous amount of data (e.g., queries in the form of phrase, sentence, paragraph, etc.) is being collected from users, documented and processed to perform various operations. In an automated customer service system, when a customer inputs a wide variety of queries, each query is directed to different servers for obtaining a relevant reply.

For instance, an automated customer service system may support different customers, and when a customer raises a query specific to a division (e.g., home appliances), the query is communicated to a server (or a virtual server or any device) of that particular division to obtain a relevant reply which is then presented to the customer.

However, in many situations, automated customer service systems are inaccurate in understanding the queries as the customers tend to converse like they are talking to a real human, due to various reasons (including, misunderstanding the chatbot as a real human, frustrated with irrelevant replies, etc.). For example, when a user discussing about a cooler device, enters the sentence “that was cold”, the automated customer service system may misunderstand that the sentence as “the cooler makes the air cold”, instead of the real meaning “the reply was insensitive”. The present invention provides a system for automated refinement of the sentiment of a document (e.g., phrase, sentence, etc.) through machine learning-driven recalibration. The present invention also provides a system that is highly adaptable with minimal updates to make it immediately sensitive to real-time language and trend shifts (e.g., social media lingo, trending words, etc.). Even the present disclosure discusses the invention with respect to automated customer service systems, it is to be understood that the teachings from the present disclosure are equally applicable to other applications as well, which include, without limitations, home automation systems, and industrial control systems.

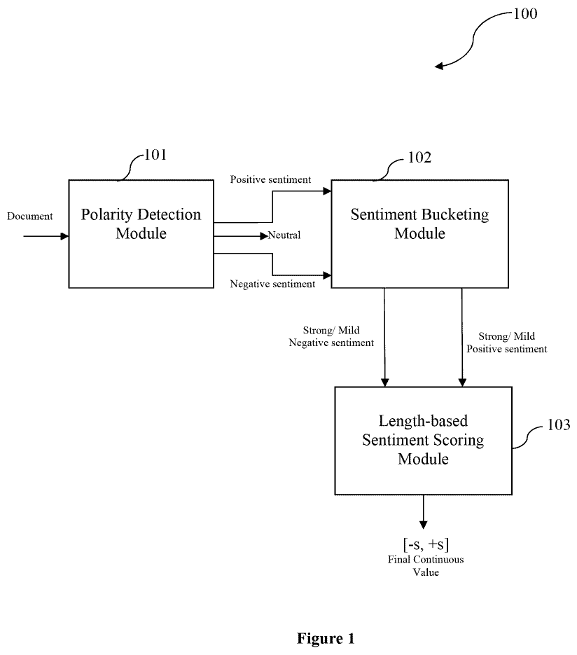

FIG. 1 illustrates a block diagram of a system for fine-grained sentiment analysis using a hybrid model. The system (100) comprises a polarity detection module (101) for detecting the positive sentiments, negative sentiments, and neutral sentiments of one or more sentences in a document. Potential sentiment words in the sentences having the detected sentiments (i.e., except neutral sentiments) are compared with a general-language lexicon to rank the sentiment words. Sentences containing new words that are not in the general-language lexicon are isolated and analyzed to rank the new words.

Further, following polarity detection by module (101), a sentiment bucketing module (102) classifies sentences identified as having positive or negative sentiment into predefined intensity categories, specifically distinguishing between ‘Mild’ and ‘Strong’ sentiment (e.g., “Mild Positive”, “Strong Positive”, “Mild Negative”, “Strong Negative”). This classification is crucial for fine-grained analysis, providing an initial assessment of emotional intensity. In an exemplary embodiment, this module (102) utilizes a trained machine learning model, such as a transformer-based neural network architecture, specifically fine-tuned for this classification task. The model is trained on a curated dataset where sentences were previously tagged by human annotators based on the perceived intensity of emotion elicited (Mild vs. Strong). While the precise internal weighting learned by the model determines the classification boundary, the module's function is to receive a sentence with non-neutral polarity and output a classification label (e.g., ‘Strong Negative’) indicating its predicted bucket. This bucketing provides a crucial feature and reference interval used in subsequent scoring steps and for validating the final sentiment score range.

Furthermore, the system (100) comprises a length-based sentiment scoring module (103) for assigning a continuous score to the classified sentences in the document ranging between −s to +s, wherein −s indicates extremely negative sentiment of the sentence and +s indicates extremely positive sentiment of the sentence. In one embodiment, the length-based sentiment scoring module (103) assigns a continuous sentiment score to the classified sentences from multiple languages.

The length-based sentiment scoring module (103) assigns a continuous score to the classified sentences (output from module 102), typically ranging between −s to +s, where −s indicates extremely negative sentiment and +s indicates extremely positive sentiment, and ‘s’ is a configurable non-zero real number (e.g., s=1). The process involves:
a. Parsing the sentence using linguistic tools (e.g., part-of-speech taggers, dependency parsers) to identify affect words, referencing general and domain-specific sentiment lexicons which contain predefined scores for known affect words.
b. Calculating a raw cumulative score by summing the predefined scores of the identified affect words.
c. Applying a weighting adjustment for repeated affect words. To effectively capture the impact of repeated occurrences of affective expressions on the sentiment intensity score—without disproportionately amplifying the overall score—a weighting factor (e.g., a default incremental boost of 10%, configurable) may be applied to the score contribution of each affective term upon repetition (a maximum of up to three times, resulting in a maximum 30% boost for that specific expression's contribution), considering only unique affect words or expressions for the divisor in the next step. For example, in “This is good good good good good!”, the score for “good” might be boosted up to a maximum of three times, each time by 10% (since it appears >=three times) before normalization.
d. Normalizing the (potentially weighted) cumulative score. The normalized score is calculated as: Normalized Score=Sum (Scores of identified affect words with weighting)/Count (Unique words identified in the sentence). This normalization based on the count of unique affect words ensures that sentiment density, rather than raw word count, drives the score.
e. Scaling the normalized score, typically to a range like [−1, +1], based on observed empirical minimum and maximum normalized scores across a representative dataset.
f. Extending the scaled score to the final range [−s, +s] by multiplying with the scaling factor ‘s’.
g. Optionally applying post-scoring adjustments based on the bucket classification from module (102), as described in the forthcoming paragraphs.

Unlike conventional sentiment analysis systems that normalize based on total affect-word count, our normalization approach considers weighted scores of unique words based on frequency rather than all instances of affect words. This innovation directly addresses a common problem in sentiment analysis where repeated use of the same affect word might disproportionately inflate score

The system (100) has been explained using the following example as an aid for the purpose of simple understanding. The system (100) calculates the fine-grained sentiment using statistical methods, semantic methods, and keyword spotting for textual data. A document is first classified as positive, negative, or neutral by the polarity detection module (101), e.g., “I love this Product” is positive; “I got an allergic reaction using this product” is negative and “I received product” is neutral. Further, the sentiment bucketing module (102) classifies the polarity classified document as “Strong Positive” or “Mild Positive” and “Strong Negative” or “Mild Negative”. E.g., “I got an allergic reaction using this product” and “I hate this product” are bucketed as “Strong Negative”, whereas “I do not like this product” is a “Mild Negative”.

Subsequently, the sentiment/intensity classified document is passed through the length-based sentiment scoring module (103), wherein the length-based sentiment scoring module (103) may employ a keyword spotting and statistical method to provide final score, e.g., “I got allergic reaction using this product” is assigned a score of −0.78, whereas, “I do not like this product” is assigned a score of “−0.25” in the scaled range of [−1,1].

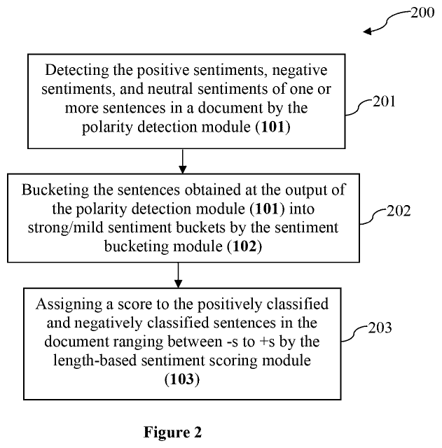

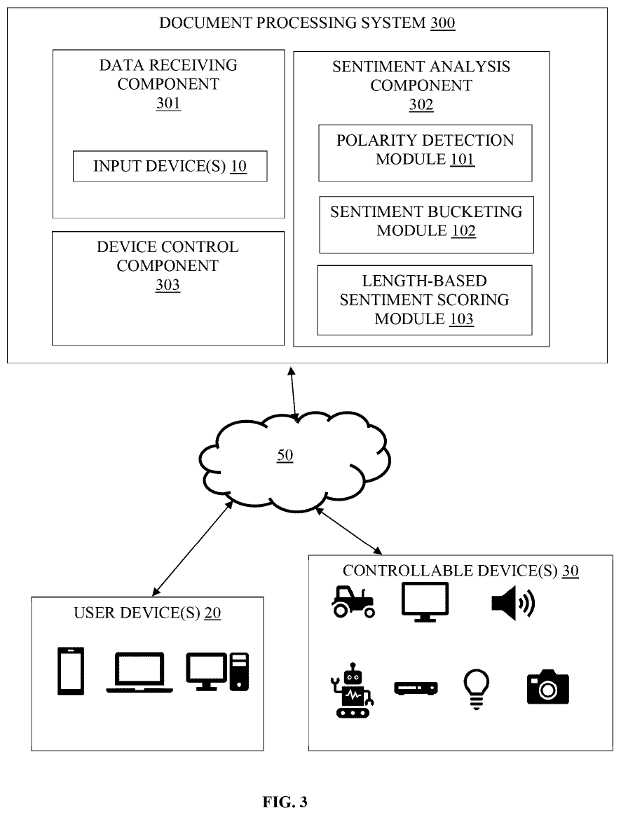

FIG. 2 illustrates a method for system for fine-grained sentiment analysis using a hybrid model, wherein the method (200) comprises the steps of detecting the positive sentiments, negative sentiments, and neutral sentiments of one or more sentences in a document by the polarity detection module (101) in step (201), wherein a deep learning model is trained to detect and separate the positive sentiments, negative sentiments and neutral sentiments of one or more sentences in the document, as shown in FIG. 3.

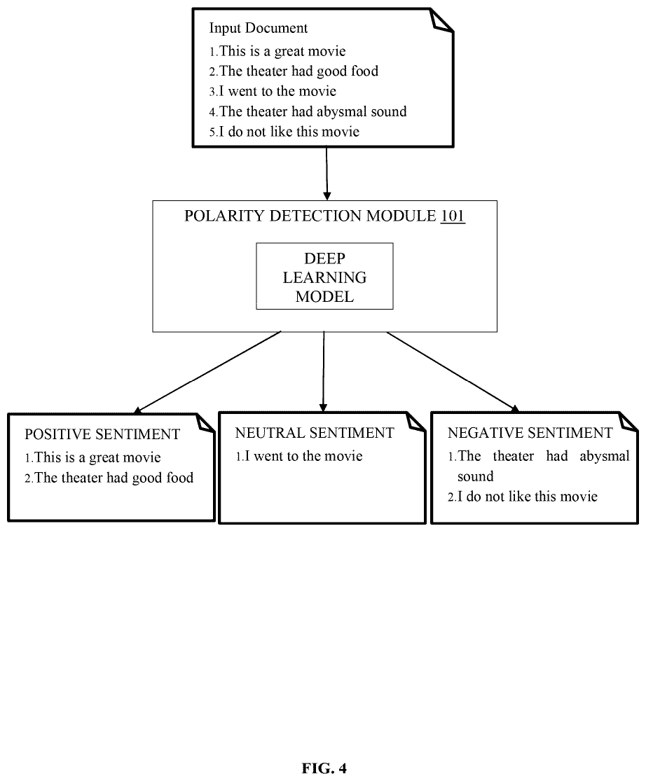

In step (202), the sentences obtained at the output of the polarity detection module (101) are classified into multiple buckets (i.e., Strong Negative, Mild Negative, Strong Positive and Mild Positive) by the sentiment bucketing module (102), as shown in FIG. 4, wherein the sentiment bucketing module (102) is trained to predict the degree (‘Mild’ vs ‘Strong’) of intensity of a positive sentiment or a negative sentiment using artificial intelligence and deep learning techniques. In step (204), the length-based sentiment scoring module (103) assigns a score to the positively classified and negatively classified sentences in the document ranging between −s to +s.

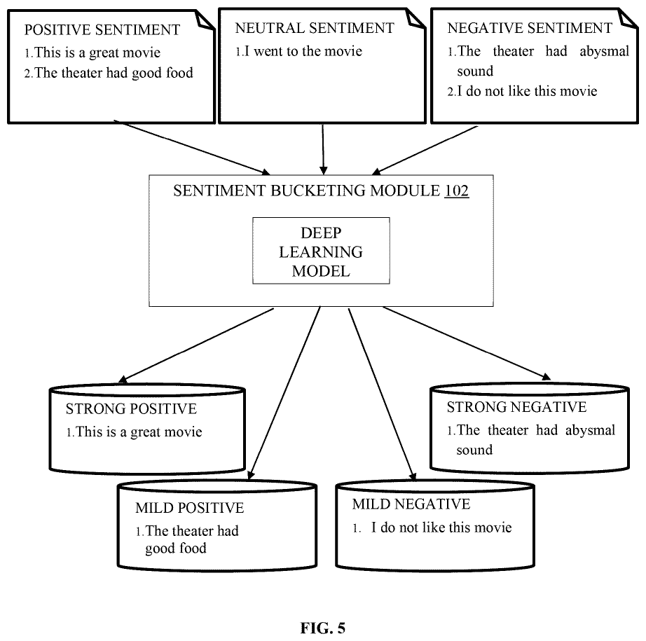

The method for assigning a score to the positively classified and negatively classified sentences in the document by the length-based sentiment scoring module (103) is shown in detailed in FIG. 5. The method for assigning the score comprises the steps of parsing each sentence in the document to find affect words and calculating the cumulative sentiment score based on the type of affect words, wherein a predefined score is assigned to each such word in the lexicon by domain experts and is updated at regular pre-defined intervals with new affect words in the lexicon. In one example, the length-based sentiment scoring module (103) includes a specialized tool(s) that understands the grammatical structure of a sentence, and the structural dependencies of a sentence. Subsequently, the cumulative sentiment score is normalized based on the number of valid, unique affect terms, wherein the normalized score is scaled between −1 and +1 based on the observed empirical extremes of the normalized scale. The range of the penultimate score is extended to [−s, +s] by multiplying the penultimate score with “s” thereby resulting in the final score, wherein “s” is a real non-zero number.

Affect/emotion words, within the context of this document, are words that are grammatically and structurally likely to ‘modify’ the subject or the object of a sentence. These words are defined by their capacity to depict feelings, emotional states, quantifiers, etc. For e.g., in the sentence, “The jolly person gave me a candy.”, the word “jolly” defines the attribute of the subject “person”. Similarly, words like ‘hate’ in the sentence, “I hate this product”, quantify the degree of emotion expressed. These terms can be identified by using a combination of specialized tools (i.e. Parts-of-Speech tagger and Dependency Parser) built with transformer network architectures, which leverage the latest advances in understanding grammar and language. The specialized tools required understand the grammatical structure of a sentence, and the structural dependencies of a sentence. Furthermore, these specialized tools analyze the grammatical structure of a sentence to determine relationships between words (e.g., identifying which adjective modifies which noun, or which adverb modifies which verb or adjective using Parts-of-Speech tagging and Dependency Parsing), which is a quintessential step before assigning a score to any affect word. The affect words are identified through a multi-step process:
(a) part-of-speech tagging to identify adjectives, adverbs, and sentiment-carrying verbs;
(b) dependency parsing to determine which words modify core sentence components; and
(c) validation against lexicon entries.
Words satisfying at least two criteria from the above are to be considered valid affect words.

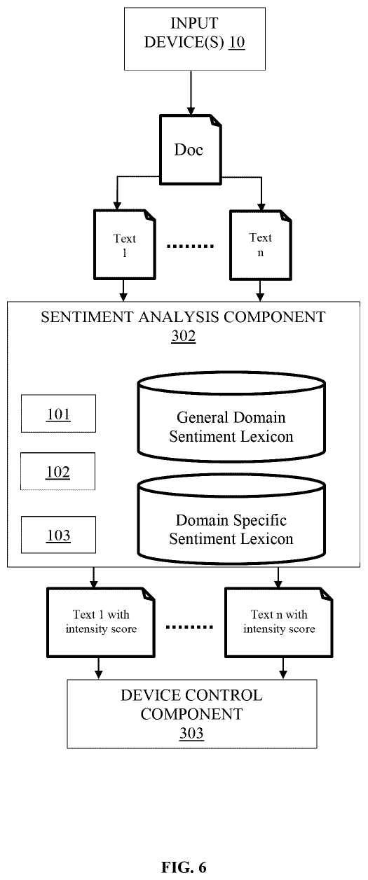

The process of assigning a score to the positively classified and negatively classified sentences in the document is done by the length-based sentiment scoring module (103). The specialized tools used in the length-based sentiment scoring module (103) help in understand the ‘type’ of affect words in a sentence. The module then uses this information primarily as a validation step: ensuring that a potential affect word identified via lexicon lookup is indeed grammatically modifying the relevant subject, object, or aspect of the sentence before its score is included in the calculation. For example, in ‘This product is like gold’ vs. ‘I like this product’, dependency analysis helps distinguish the comparative use of ‘like’ (not an affect word in this context) from the verb expressing preference (an affect word). This prevents incorrect scoring based on spurious word matches and improves the accuracy of the fine-grained analysis. The scoring process is explained by the following example, with reference to FIG. 6. In a sentence, it can be noticed that not all the words contribute to the sentiment of the sentence, but only a few words do, which are the affect/emotion words. Every affect word is assigned a value relative to other affect words, e.g., “love” is relatively stronger sentiment than “like” and “allergic reaction” is stronger sentiment than “do not like”. The method (200) considers valid individual affect word scores and calculates the overall text score. The normalization process ensures that sentiment density, rather than simply the raw count of affect words or document length, determines the final score. The scale of sentiment intensity is placed in the range of [−s,+s] as a multiplier.

Parsing of affect words entails, finding the affect words in a document using the human-built lexicon and determining the polarity of the sentence. Further, the scores of all the affect words are combined to get a cumulative score, wherein the affect words' contribution is normalized by taking into account validity of affect words and number of unique affect words. Subsequently, statistical methods are applied to scale the intensity based on the classified document, e.g., “I got an allergic reaction using this product” is scaled to be close to −s whereas “I had a great time using this product” is scaled to be close to +s.

The present invention provides a continuous sentiment intensity system which is flexible, extensible to multiple languages and capable of accurately predicting a continuous sentiment value for variable kinds of texts that comprise a single phrase, a sentence, a large set of sentences and so on. In addition to being multilingual, the present invention is better compared to the existing technologies in terms of accuracy and robustness. Unlike conventional methods like VADER, which uses a simple rule-based approach with fixed intensifiers and cannot adapt to new vocabulary without manual updates, our system employs a three-stage architecture with cross-validation between supervised learning (bucketing) and lexicon-based (scoring) approaches. Where VADER struggles with out-of-vocabulary terms and context-dependent sentiment shifts, the disclosed hybrid system dynamically updates lexicons, allowing continuous adaptation to emerging terminology. The disclosed hybrid system overcomes these limitations as follows:
a. Accurate Fine-Grained Analysis: The combination of bucketing and the unique length-based scoring (103), which normalizes scores by unique affect word count provides a nuanced, continuous sentiment score. This is invaluable for applications like customer feedback analysis, allowing businesses to prioritize actions by understanding not just what aspects customers dislike/like, but how intensely they feel, enabling ranking of reviews from most critical/actionable to least.
b. Robustness and Reliability: The hybrid architecture, where the transformer based bucketing and the lexicon/rule-based scoring cross-validate each other, makes the system resilient to anomalies or misclassifications inherent in any single approach. This ensures a smoother, statistically sound distribution of sentiment scores.
c. Adaptability and Scalability: The iterative refinement process for scoring new words using semantic similarity (e.g., via transformer embeddings) allows the system to quickly adapt to new domains, emerging lingo, and misspellings with minimal manual intervention. The reliance on fundamental grammatical structures and dependency parsing for identifying affect words enhances scalability to multiple languages, as these linguistic constructs are often preserved across languages.
d. Industry Relevance: This system addresses a key industry need for performant, adaptable fine-grained sentiment analysis. This system outperforms existing systems that leverage similar data-flows due to technical advancements at each modular step (e.g. more accurate classification models based on transformer architectures), robust checks and mechanisms against classification missteps, as well as combating inflexible nature of lexicon updates used by conventional solutions like VADER. It enables deeper understanding of customer voice, market trends, and employee feedback by providing accurate, context-aware, and intensity-sensitive sentiment scores, moving beyond simple positive/negative/neutral classifications.

Unlike the existing technologies which are rule based and are not scalable and robust, the present invention is scalable in terms of the sentiment intensity, which is measured on a variable scale, wherein different intensities are assigned to the document of any given length.

FIG. 3 illustrates a document processing system (300) for fine-grained sentiment analysis using a hybrid model for processing a document in an automated customer service system. The system (300) comprises a document receiving component (301), a sentence analysis component (302) and a device control component (303). The document receiving component (301) receives the document comprising at least one sentence. In one example, the document receiving component (301) comprises an input device(s) (10), such as a keyboard, touchscreen, joystick, mouse, etc., used by a user(s) for inputting the document. In another example, the document receiving component (301) is communicatively connected to a user device(s) (20), e.g., portable computing device, desktop computing device, smartphone, etc., through a wireless communication network (50) or a wired means for receiving the document. In some examples, the document receiving component (301) is an interface component of a processing server or the like.

It is to be understood that the document can include, but not limited to, any text document (e.g., Microsoft® Word file, portable document format (PDF) file, etc.) or mere text data obtained from typing, clicking, or keying in process. In some examples, the text data is obtained by converting an audio clip(s) or an image(s) (still or moving images) using voice recognition or character recognition (e.g., optical character recognition) process.

The sentence analysis component (302) analyzes each sentence (complete sentence or phrase) in the document using a hybrid model to identify a sentiment of the document. The hybrid model comprises a polarity detection module (101), a sentiment bucketing module (102), and a length-based sentiment scoring module (103). In one example, at least one of the polarity detection module (101), the sentiment bucketing module (102), and the length-based sentiment scoring module (103) is a predictive or a machine-learning model, such as supervised learning and unsupervised learning.

The polarity detection module (101) detects positive sentiments, negative sentiments, and neutral sentiments of each sentence in the document. The sentiment bucketing model (102) classifies the identified polar sentences into their respective Mild/Strong buckets. Positive sentences are separated into Mildly Positive and Strongly Positive Bucket, whereas the Negative sentences are separated into the Mildly Negative and Strongly Negative Bucket. Note that the statements identified as Neutral sentiments are not further classified. The sentiment bucketing module (102) provides a reference sentiment interval for the classified sentences in the document. This differentiation helps us validate and interpret what the expected range of score a sentence should fall into.

The length-based sentiment scoring module (103) assigns a score to the classified sentences in the document, where a continuous score ranging between −s to +s is assigned to each classified sentence by employing statistical, semantic and keyword spotting methods. −s indicates extremely negative sentiment of the sentence, and +s indicates extremely positive sentiment of the sentence, wherein “s” is a real non-zero number.

The length-based sentiment scoring module (103) is operable to parse each document to find affect words, calculates a cumulative sentiment score based on a type of affect words and assigns a predefined score to each affect word in lexicon.

The length-based sentiment scoring module (103) normalizes the cumulative sentiment score, scales the normalized score between −1 and +1 based on observed empirical extremes of a normalized scale, and extends a range of a penultimate score to [−s,+s] by multiplying the penultimate score with “s” thereby resulting in a final score.

The device control component (303) is operable to generate a control command(s) based on the identified sentiment to control a controllable device(s) (30). In one example, the device includes, but not limited to, a display device (e.g., liquid crystal display (LCD), light emitting diode (LED) display, a plasma display, etc.) an audio device (e.g., loudspeaker), a portable computing device (e.g., smartphone, laptop computer, etc.), a server computer, a communication device (e.g., transceiver), a home automation device (e.g., sensor, timer, fan, heating, ventilating, air conditioning (HVAC) device, lighting device, kitchen appliance, bathroom fittings, electromechanical systems, entertainment devices, etc.), and industrial systems (e.g., manufacturing machinery (e.g., lathe machine, computer numerical control (CNC) machine, transportation system (e.g., crane, conveyor, etc.), etc.). In one example, based on the detected sentiment, the device control component (303) determines the context of data included in the document, and then generates the control command(s). In one example, the control command(s) is to operate the display device and/or the audio device to prompt (e.g., by generating a user interface having an image or text, by generating an audible output, etc.) the user to input a data (e.g., clarification to the query, additional information needed to understand the query, etc.). In one example, the control command(s) is to operate an HVAC device in a room in response to a sentence (e.g., am feeling so sweaty) received from a user sitting in the room. In another example, the control command(s) is to drive machinery (e.g., crane) in a warehouse to move a package in response to a sentence (e.g., that truck is packed like a sardine can) received from a supervisor inspecting a loading operation in the warehouse. In some examples, the control command is to operate a communication subsystem to fetch a reply document in response to the analyzed document.

The present invention automatically refines sentiment scores through machine learning-driven recalibration including adaptive, accurate and consistent auto-scoring for new terms that have not been seen/scored before. This model is based on identifying meaning between words. This method gives us a ‘semantic similarity score’ which is based on how close in meaning/spelling any two terms are. The hybrid model automatically finds the most relevant term that shares the same/similar meaning to a previously-unseen term and dynamically identifies intensity scores for these new terms. This method outperforms all existing methods by taking care of possible misspellings and new words altogether (e.g., fantabulous, super-duper-hit, etc.).

The present invention is highly adaptable with minimal updates to make it immediately sensitive to real-time language and trend shifts (e.g. social media lingo, trending words, etc.), wherein intensity scores can fall into expected ranges, i.e., a mildly polar sentence should have an intensity in the range of [0, mild polarity (MP) score] and a strongly polar sentence is expected to have an intensity score [MP score, s].

The hybrid nature of the system involves a sequential data flow and cross-validation between modules. Input text first undergoes polarity detection (101). Sentences classified as neutral bypass further intensity analysis and are assigned a score of 0. Non-neutral sentences proceed to the sentiment bucketing module (102) for Mild/Strong classification. Subsequently, the length-based sentiment scoring module (103) calculates a continuous score as aforementioned. Crucially, the bucketing classification serves as input for a final score validation and adjustment step within or following module (103). If a calculated score for a sentence deviates significantly (e.g., more than one standard deviation) from the established average score range for its assigned bucket within that domain (e.g., a sentence bucketed as ‘Mild Positive’ receives a score far exceeding the typical range for Mild Positive sentences in that domain's lexicon), the score is adjusted. Specifically:
If a score is significantly higher than its ‘Mild’ bucket's range, it may be dampened to fall closer to the upper boundary of that range.
If a score is significantly lower than its ‘Strong’ bucket's range, it may be boosted to fall closer to the lower boundary of that range.

This adjustment ensures scores remain consistent with the intensity bucketing, providing robustness against potential misclassifications by either the bucketing or initial scoring stages. It promotes a smoother, more continuous sentiment spectrum across buckets, potentially allowing for slight overlaps in score ranges between adjacent buckets (e.g., high-end Mild Positive and low-end Strong Positive), reflecting the nuanced nature of sentiment intensity. This cross-validation between the machine-learned bucketing and the lexicon/rule-based scoring enhances overall system accuracy and reliability, particularly in domains with well-populated lexicons (e.g., >200 terms). The following error correction mechanisms are of particular significance: (a) In cases where the length-based sentiment scoring module (103) assigns a lower sentiment intensity score due to the absence of certain words or expressions in its lexicon—thereby erroneously placing the text within the ‘Mild’ sentiment bucket—the sentiment bucketing model (102) may correctly classify the same text within the ‘Strong’ sentiment bucket. To reconcile this discrepancy, the sentiment intensity score is adjusted toward the lower bound of the ‘Strong’ bucket, thereby minimizing classification deviation. (b) Conversely, if the length-based sentiment scoring module (103) assigns a sentiment intensity score corresponding to the ‘Strong’ bucket, but the sentiment bucketing model (102) classifies the same text within the ‘Mild’ bucket, the likely cause is a lack of corresponding training data within the sentiment bucketing model (102), despite relevant lexical entries being present in the length-based scoring module (103). In such instances, the sentiment intensity score is adjusted marginally beyond the upper bound of the ‘Mild’ bucket to compensate for the discrepancy and ensure accurate classification

In one example, the document comprising a plurality (for e.g., 500-1000) of complete sentences (e.g., relevant to a specific area or domain) is received and scanned using the aforementioned language analysis tool(s) that understand grammar and sentence structure to pinpoint words likely used to express feelings or opinions. Sentences that are purely factual or neutral are filtered, as they do not contribute to the intensity of a sentiment. In one example, the sentences are filtered by running the plurality of sentences on a Sentiment Polarity model.

Potential sentiment words in the remaining sentences are compared with a general-language lexicon to rank the sentiment words. Sentences containing missing words that are not in the general-language lexicon are analyzed in isolation to rank/score the new words. In one embodiment, the scoring of missing words is done by calculating semantic similarity of the missing words to existing words in the lexicon using their word embeddings (e.g., BERT-MNLI and other transformer variants). These advanced models work by splitting a word into its constituent sub-parts, enabling effective representation of even misspelled, rare, or entirely new terms (e.g., ‘fantabulous’). This ensures that nuance is captured even if the word is a combination of words, a misspelled term, or an entirely new term.

In one example, ranking/scoring of a new word is executed in two stages. Initially, sentences including any new words are ranked relative to each other and with respect to the anchor sentences. In the second stage, an assumption is made that the ranking of the sentences is in correct order, and the scores of the respective affect words of these sentences are iteratively refined based on rank.
For example,
Lets assume that the sentence ‘I am thoroughly flummoxed by the instructions’ has a rank 15, and the sentence ‘The instructions are pretty confusing’ has a rank 10.

Note that higher rank shows more intensity, i.e. the sentence at rank 15 depicts a higher intensity score than rank 10. This means that the respective affect word scores of these sentences should align accordingly. Particularly, the term ‘thoroughly flummoxed’ should have a higher score than ‘pretty confusing’, based on the ranks of these two sentences.

Since the word ‘thoroughly’ is already common word and should exist in the general domain lexicon, we should be able to refine the intensity score for ‘flummoxed’ to be higher than the intensity score for ‘confusing’. Words most similar in meaning to ‘flummoxed’ in the lexicon is found using the mathematical representation of the word, and then finding its closest semantic neighbors. This gives a general area around which the final score for this word is expected to be.

This iterative refinement process leads to find ideal and statistically relevant scores for words that are unseen for a domain, and are updated automatically as described above.

Using a bucketing model, an initial assessment of the isolated sentences is performed to categorize them into “Mild Positive”, “Strong Positive”, “Mild Negative”, “Strong Negative” buckets. From each bucket, a small, representative sample of sentences (e.g., around 20) is manually selected and prioritized based on the clarity of contribution of the new words to sentiment.

A set of “anchor” sentences containing words of known sentiment (e.g., “terrible”, “excellent”, etc.) is included to provide context. The selected sentences and the “anchor” sentences are manually ranked and arranged in order according to their rankings, from the least intense feeling to the most intense. Based on the rankings, the selected sentences are assigned an initial sentiment strength score that is in line with the rankings of the anchor sentences. This score is iteratively refined at the affect-word level, and calibrated per affect word identified in the sentence.

The iterative refinement process for a new affect word involves:
a. Generating an embedding vector for the new word in its sentence context using the advanced transformer models as aforementioned.
b. Calculating similarity (e.g., using cosine similarity) between the new word's vector and the vectors of known words already present in the sentiment lexicons (these are called nearest neighbors—NNs).
c. Filtering NNs based on relevance, prioritizing NNs with the same Part-of-Speech (POS) as the new word and sorting by similarity score.
d. Identifying a candidate score range for the new word based on the scores of the top ‘n’ most relevant NNs. For instance, the range might be defined by [0.8*score (lowest scoring relevant NN), 1.2*score (highest scoring relevant NN)].
e. Assigning an initial score to the new word within a granular scale (e.g., increments of 0.02) derived from this range.
f. Evaluating the assignment by comparing the rank order of sentences containing the new word (scored using the assigned value) against a reference rank order provided by human judges (who rank a set of ˜20 sentences, including anchor sentences with known sentiment words like ‘terrible’ or ‘excellent’, from least to most intense).
g. Iteratively adjusting the assigned score for the new word using a search strategy (e.g., akin to binary search) based on the deviation between the calculated rank and the human rank. This adjustment considers the magnitude of the rank difference and the scores of the closest/farthest anchor sentences in the human ranking to guide the score calibration.
h. Repeating the adjustment until convergence criteria are met, such as reaching a minimum average rank deviation from human judgment across the set or achieving a rank accuracy within a predefined threshold (e.g., average rank deviation <=2 positions out of 20).
This calibration is automatic, based on statistical ranking and relative scoring between terms of similar semantic meaning.

These initial sentiment scores are iteratively adjusted by the hybrid model for improving the accuracy based on the manual rankings. The scores are fine-tuned until the ranks best reflect the observed human judgments. To ensure reliability, the final scores are verified by manually reviewing them. Thereby, the present invention compares meanings to each new word in the document with that of the words of the “anchor” sentences and assigns a score based on the closest, already-understood words, ensuring even rarer terms are calibrated. This leads to assigning reliable, context-specific sentiment intensity scores to the most important new words identified for any domain. Furthermore, the new words and their corresponding scores are added to a corresponding domain-specific sentiment dictionary, enhancing the understanding of that context.

Also, the present invention subtly adjusts the scores of the known words (both general and domain-specific) if the scores of the newly identified words suggests the intensity of the known words is different in that particular context. These words with different scores for the same terms are also added to the domain lexicon. The understanding is that the new score reflects the score of the term with respect to the domain, and it maintains the original score in the general lexicon. This ensures the entire sentiment lexicon remains accurate for the domain, as well as calibrating changes on the general lexicon. When a significant amount of new knowledge is integrated, the present invention automatically triggers a process to retrain the bucketing model.

This entire cycle—identifying new terms, scoring them with human oversight, integrating them, and automatically retraining/validating the system components—operates with minimal manual intervention as a self-calibrating, self-improving loop. This makes the system highly adaptable and efficient for new domains and even new languages, as the fundamental process remains the same. The present invention achieves this by relying on underlying grammatical and sentence-structure of a language, where affect words are represented by the same parts of speech/dependency structures. Thus, the present invention not only provides accurate intensity scores but also automatically adapts, calibrates, and improves its own performance as it encounters new language patterns, ensuring sustained accuracy and relevance across diverse domains.

While at least one exemplary embodiment has been presented in the foregoing detailed description, it should be appreciated that a vast number of variations exist.

### REFERENCE NUMBERS

| Components | Reference Numbers |
|---|---|
| Input device(s) | 10 |
| User device(s) | 20 |
| Controllable device(s) | 30 |
| Wireless communication network | 50 |
| System | 100 |
| Polarity detection module | 101 |
| Sentiment bucketing module | 102 |
| Length-based sentiment scoring module | 103 |
| Document processing system | 300 |
| Document receiving component | 301 |
| Sentence analysis component | 302 |
| Device control component | 303 |

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

We claim:

1. A document processing system for fine-grained sentiment analysis of a document, the system comprising:
a. document receiving component for receiving the document comprising at least one sentence;
b. a sentence analysis component for analyzing each sentence in the document using a hybrid model to identify a sentiment of the document, wherein the hybrid model comprises:
i. a polarity detection module for detecting positive sentiments, negative sentiments, and neutral sentiments of one or more sentences in the document;
ii. a sentiment bucketing module for predicting a predefined reference bucket of sentences classified as positive sentiment or negative sentiment; and
iii. a length-based sentiment scoring module for assigning a score to the classified sentences in the document, wherein the length-based sentiment scoring module (103) assigns a continuous score to the classified sentences ranging between −s to +s by employing statistical, semantic and keyword spotting methods, wherein −s indicates extremely negative sentiment of the sentence and +s indicates extremely positive sentiment of the sentence, wherein “s” is a real non-zero number,
wherein the length-based sentiment scoring module is operable to:
parse each document to find valid affect words;
calculate a cumulative sentiment score based on a type of affect words and assign a predefined score to each valid affect word in lexicon;
normalize the cumulative sentiment score based on predefined scores of unique affect words, a potential weightage factor dependent on number of occurrences of an affect word, and the number of such unique words in the document;
scale the normalized score between −1 and +1 based on observed empirical extremes of a normalized scale; and
extend a range of a penultimate score to [−s,+s] by multiplying the penultimate score with “s” thereby resulting in a final score; and
c. a device control component for controlling at least one controllable device based on the identified sentiment.

2. The system as claimed in claim 1, wherein the device control component controls a communication subsystem to fetch a reply document in response to the analyzed document.

3. The system as claimed in claim 1, wherein the device control component controls a display device to generate a user interface.

4. The system as claimed in claim 1, wherein the device control component controls an audio device to generate an audible output.

5. The system as claimed in claim 1, wherein the device control component generates a control command to drive machinery.
